(19) United States
(12) Patent Application Publication
(10) Pub. No.: US 2017/0185653 A1
(43) Pub. Date: Jun. 29, 2017

(54) Predicting Knowledge Types In A Search Query Using Word Co-Occurrence And Semi/Unstructured Free Text

(71) Applicant: Quixey, Inc., Mountain View, CA (US)

(72) Inventors: Yuheng HUANG, San Mateo, CA (US); Eric GLOVER, Palo Alto, CA (US); Cheng JIANG, San Bruno, CA (US)

(21) Appl. No.: 15/393,800

(22) Filed: Dec. 29, 2016

Related U.S. Application Data
(60) Provisional application No. 62/272,641, filed on Dec. 29, 2015.

(51) Int. Cl. G06F 17/30

(52) U.S. Cl. CPC G06F 17/30542

(57) ABSTRACT

A system provides search results in response to a search query. The system includes a query understanding module configured to receive the search query and output a processed search query based on the search query. The search query includes one or more words and the processed search query selectively includes tags assigned to the one or more words. The system includes a fuzzy knowledge module configured to receive the processed search query, generate a set of candidate tags for selected ones of the words in the search query, and selectively validate the candidate tags. The system is configured to provide the search results to a user device based in part on the candidate tags generated and validated by the fuzzy knowledge module.

### CROSS-REFERENCE TO RELATED APPLICATIONS

This application claims the benefit of U.S. Provisional Application No. 62/272,641, filed on Dec. 29, 2015. The entire disclosure of the application referenced above is incorporated by reference.

### FIELD

This disclosure relates to systems and methods for generating search results.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Various devices may be used to perform a search to generate search results. For example, a user may provide a query using an input interface of a device. The query is provided to a search system. The search system generates search results in response to the query and provides the search results to the user via the device.

### SUMMARY

A system provides search results in response to a search query. The system includes a query understanding module configured to receive the search query and output a processed search query based on the search query. The search query includes one or more words and the processed search query selectively includes tags assigned to the one or more words. The system includes a fuzzy knowledge module configured to receive the processed search query, generate a set of candidate tags for selected ones of the words in the search query, and selectively validate the candidate tags. The system is configured to provide the search results to a user device based in part on the candidate tags generated and validated by the fuzzy knowledge module.

In other features, each of the tags identifies an entity associated with the respective word in the search query. In other features, the selected ones of the words in the search query correspond to at least one of (i) words in the search query that were not assigned a respective tag by the query understanding module and (ii) words in the search query that were assigned, by the query understanding module, a respective tag associated with a confidence value less than a threshold. In other features, the fuzzy knowledge module generates the set of candidate tags in response to a determination that none of the words in the search query were assigned tags by the query understanding module. In other features, the fuzzy knowledge module is further configured to predict a respective action group associated with each of the selected ones of the words in the search query. The respective action groups correspond to one or more functions related to the selected ones of the words in the search query.

In other features, the fuzzy knowledge module is further configured to assign a likelihood score to each of the action groups. The likelihood score indicates a probability that the search query will be satisfied by search results from within the respective action group. In other features, the fuzzy knowledge module is further configured to compare the words in the search query to sets of grammar rules associated with each of the respective action groups. In other features, the fuzzy knowledge module is further configured to assign a grammar match score to each of the sets of grammar rules based on the comparison. In other features, the fuzzy knowledge module is further configured to segment the search query based on the action groups and the sets of grammar rules. In other features, each of the candidate tags includes a word in the search query, a knowledge type identifier, and an action group identifier.

A method of providing search results in response to a search query includes receiving the search query. The method includes outputting a processed search query based on the search query. The search query includes one or more words and the processed search query selectively includes tags assigned to the one or more words. The method includes generating a set of candidate tags for selected ones of the words in the search query. The method includes selectively validating the candidate tags. The method includes providing the search results to a user device based in part on the validated candidate tags.

In other features, each of the tags identifies an entity associated with the respective word in the search query. In other features, the selected ones of the words in the search query correspond to at least one of (i) words in the search query that were not assigned a respective tag and (ii) words in the search query that were assigned a respective tag associated with a confidence value less than a threshold. In other features, the method includes generating the set of candidate tags in response to a determination that none of the words in the search query were assigned tags. In other features, the method includes predicting a respective action group associated with each of the selected ones of the words in the search query. The respective action groups correspond to one or more functions related to the selected ones of the words in the search query.

In other features, the method includes assigning a likelihood score to each of the action groups. The likelihood score indicates a probability that the search query will be satisfied by search results from within the respective action group. In other features, the method includes comparing the words in the search query to sets of grammar rules associated with each of the respective action groups. In other features, the method includes assigning a grammar match score to each of the sets of grammar rules based on the comparison. In other features, the method includes segmenting the search query based on the action groups and the sets of grammar rules. In other features, each of the candidate tags includes a word in the search query, a type identifier, and an action group identifier.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The details of one or more examples are set forth in the accompanying drawings and the description below. Other features, objects, and advantages will be apparent from the description and drawings, and from the claims.

FIG. 1 illustrates an example environment including a search system.

FIG. 2 illustrates an example user device in communication with a search system.

FIG. 3A illustrates an example search record.

FIG. 3B illustrates an example entity record.

FIG. 4 is a functional block diagram of an example search module.

FIG. 5 is a functional block diagram of an example query analysis module.

FIG. 6 is a flow diagram illustrating an example method for performing a search.

FIG. 7A is a flow diagram illustrating an example method for providing validated candidate tags.

FIG. 7B is a flow diagram illustrating another example method for providing validated candidate tags.

In the drawings, reference numbers may be reused to identify similar and/or identical elements.

### DETAILED DESCRIPTION

Search systems and corresponding methods of the present disclosure receive a query wrapper from a user device that may include a search query and additional data (e.g., geo-location data). The search system processes the search query, generates search results based on the processed search query, and transmits the search results to the user device. The search system of the present disclosure analyzes the processed search query prior to generating the search results and, based on the analysis, selectively supplements the generation of the search results with additional information.

The search system stores records (referred to herein as “search records”) that the search system may use to implement the search techniques of the present disclosure. Each search record may include one or more access mechanisms, record information, and link data that the search system may use to generate the search results. The search system may transmit access mechanisms and link data in the search results that the user device may use to generate user selectable links for accessing application functionality (e.g., web states and/or native application states). Access mechanisms may include native application access mechanisms and web access mechanisms used to access functionality of native applications (e.g., installed on the user device) and web applications/websites, respectively. Access mechanisms may also include application download addresses that indicate sites (e.g., web/native) where a native application can be downloaded in the scenario where the native application is not installed on the user device. The link data may include images/text used by the user device to render the user-selectable links.

In general, the record information may include searchable data (e.g., data fields including text) that the search system may use to identify and score the search records. In some examples, the record information of a search record includes data that describes an application state into which an application is set according to the access mechanism(s) of the search record. For example, the record information of a search record may include data that may be presented to the user by an application when the application is in the application state specified by the access mechanism(s) of the search record.

In operation, the search system receives a query wrapper from the user device and processes the search query. The search system identifies a plurality of search records based on the processed search query. In some implementations, the search system may identify search records based on matches between terms of the search query and terms included in the record information of the search records.

The search system may generate scores for the identified search records that indicate the relevance of the search records to the data included in the query wrapper (e.g., the search query). For example, the search system may score the identified search records based on tags (e.g., entity records) assigned to the terms in the search query.

The search system may then select one or more search records and generate search results based on the selected search records. For example, the search system may include access mechanisms and link data from the selected search records in the search results to be rendered by the user device.

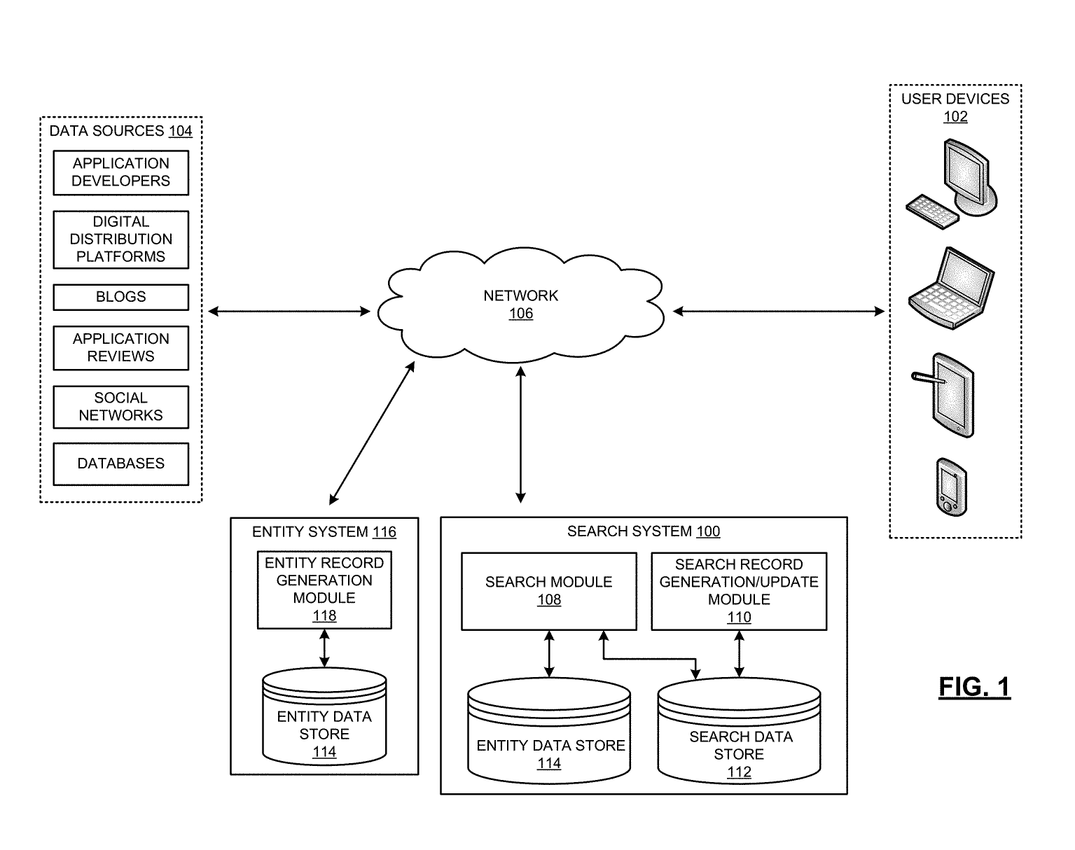

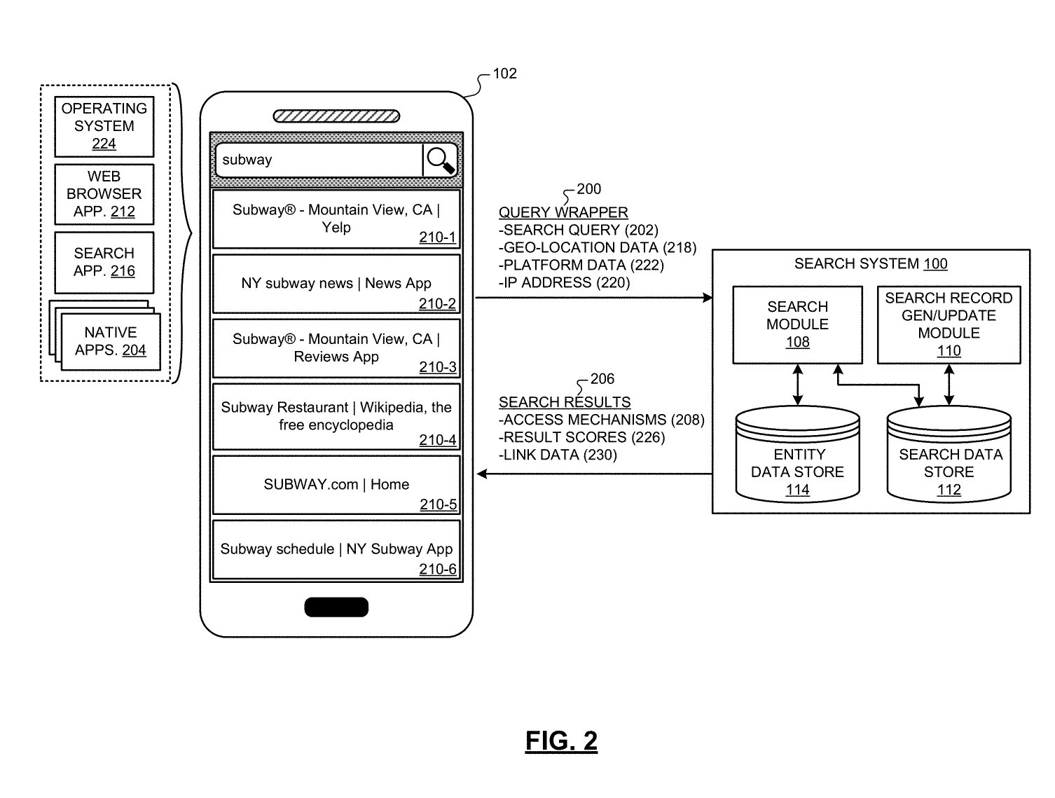

FIG. 1 is a functional block diagram illustrating an example environment including a search system 100 that communicates with user devices 102 and data sources 104 via a network 106. The network 106 through which the search system 100 and the user devices 102 communicate may include various types of networks, such as a local area network (LAN), wide area network (WAN), and/or the Internet. FIG. 2 shows an example user device 102 in communication with the search system 100 via the network 106 (not illustrated in FIG. 2).

The search system 100 includes a search module 108, a search record generation/update module 110 (hereinafter “record generation module 110”), and a search data store 112. In some implementations, the search system 100 can identify entities in the search query and then generate search results based on the identified entities. For example, the search module 108 communicates with an entity (or, knowledge) data store 114, which may be located in the search system 100 and/or in an entity system 116. The entity data store 114 stores entity records that associates entities with various data. The search module 108 receives a query wrapper 200 from the user device 102. The search module 108 analyzes (i.e., processes) the query wrapper 200 based on information included in the query wrapper 200 (such as a search query 202) and the entity records stored in the entity data store 114 to generate a processed (or, analyzed) search query. An entity record generation module 118 may generate new search records in the entity data store 114 and update existing entity records.

In implementations where the search system 100 identifies entities in the search query, an entity may refer to a person, place, or thing. For example, an entity may refer to a business, a product, a service, a piece of media content, a political organization/figure, a public figure, or a destination. In some examples, an entity may refer to a place having a defined latitude/longitude geo-location. The entity records may include an entity name/ID (e.g., a business ID/name), an entity type that indicates the category of the entity (e.g., a restaurant business), and entity information describing the entity (e.g., a restaurant address, phone number, and open hours).

In response to receiving a search query, the query analysis module may identify the entities (e.g., entity name/ID) included in the search query based on matches between terms in the search query and terms in the entity records (e.g., the entity ID, entity type, and entity information). The set generation module may identify search records based on the identified entities. For example, the set generation module may match entities in the search queries to entities included in the record information (e.g., entities associated with the state of the search record). The set generation module may select search records having matching entities for the consideration set. The set processing module may then score the search records based on matches between entities in the search query and the search records, along with other scoring features.

The search module 108 performs a search for search records included in the search data store 112 based on the processed search query. The search records include one or more access mechanisms that the user device 102 can use to access different functions for a variety of different applications, such as native applications 204 installed on the user device 102. The search module 108 transmits search results 206 including a list of access mechanisms 208 to the user device 102 that generated the query wrapper 200. As described herein, the record generation module 110 may generate new search records in the search data store 112 and update existing search records.

The user device 102 generates user selectable links based on the received search results 206 (e.g., links 210-1, 210-2, . . . , 210-6 of FIG. 2). Each user selectable link displayed to the user may include an access mechanism. A user may select a user selectable link on the user device 102 by interacting with the link (e.g., touching or clicking the link). In response to selection of a link, the user device 102 may launch the application (e.g., native application or web application) referenced by the access mechanism and perform one or more operations indicated in the access mechanism.

Access mechanisms may include at least one of a native application access mechanism (hereinafter “application access mechanism”), a web access mechanism, and an application download mechanism. The user device 102 may use the access mechanisms to access functionality of applications. For example, the user may select a user selectable link including an access mechanism in order to access functionality of an application indicated in the user selectable link. As described herein, the search module 108 may transmit one or more application access mechanisms, one or more web access mechanisms, and one or more application download mechanisms to the user device 102 in the search results 206.

An application access mechanism may be a string that includes a reference to a native application (e.g., one of native applications 204 installed on the user device 102) and indicates one or more operations for the user device 102 to perform. If a user selects a user selectable link including an application access mechanism, the user device 102 may launch the native application referenced in the application access mechanism and perform the one or more operations indicated in the application access mechanism.

A web access mechanism may include a resource identifier that includes a reference to a web resource (e.g., a page of a web application/website). For example, a web access mechanism may include a uniform resource locator (URL) (i.e., a web address) used with hypertext transfer protocol (HTTP). If a user selects a user selectable link including a web access mechanism, the user device 102 may launch the web browser application 212 and retrieve the web resource indicated in the resource identifier. Put another way, if a user selects a user selectable link including a web access mechanism, the user device 102 may launch the web browser application 212 and access a state (e.g., a page) of a web application/website. In some examples, web access mechanisms may include URLs for mobile-optimized sites and/or full sites.

An application download mechanism may indicate a site (e.g., a digital distribution platform) where a native application can be downloaded in the scenario where the native application is not installed on the user device 102. If a user selects a user selectable link including an application download address, the user device 102 may access a digital distribution platform from which the referenced native application may be downloaded. The user device 102 may access a digital distribution platform using at least one of the web browser application 212 and one of the native applications 204.

The search module 108 is configured to receive a query wrapper 200 from the user device 102 via the network 106. A query wrapper 200 may include a search query 202. A search query 202 may include text, numbers, and/or symbols (e.g., punctuation) entered into the user device 102 by the user. For example, the user may have entered the search query 202 into a search field 214 (e.g., a search box) of a search application 216 being executed on the user device 102. A user may enter a search query using a touchscreen keypad, a mechanical keypad, and/or via speech recognition.

As described herein, in some examples, the search application 216 may be a native application installed on the user device 102. For example, the search application 216 may receive search queries, generate the query wrapper 200, and display received data that is included in the search results 206. In other examples, the user device 102 may execute a web browser application 212 that accesses a web-based search application. In this example, the user may interact with the web-based search application via the web browser application 212 installed on the user device 102. In still other examples, the functionality attributed to the search application 216 herein may be included as a searching component of a larger application that has additional functionality. For example, the functionality attributed to the search application 216 may be included as part of a native/web application as a feature that provides search for the native/web application.

The query wrapper 200 may include additional data along with the search query 202. For example, the query wrapper 200 may include geo-location data 218 that indicates the location of the user device 102, such as latitude and longitude coordinates and/or an IP address. The query wrapper may also include additional data, including, but not limited to, platform data 222 (e.g., version of the operating system 224, device type, and web-browser version), an identity of a user of the user device 102 (e.g., a username), partner specific data, ISP/hostname, and other data.

The search module 108 can use the search query 202 and the additional data included in the query wrapper 200 to generate the search results 206. The search module 108 performs a search for search records included in the search data store 112 in response to the received query wrapper 200. In some implementations, the search module 108 generates result scores for search records identified during the search. The result score associated with a search record may indicate the relevance of the search record to the search query 202. A higher result score may indicate that the search record is more relevant to the search query 202. As described herein, the search module 108 may retrieve access mechanisms from the scored search records. The search module 108 can transmit a result score 226 along with an access mechanism retrieved from a scored search record in order to indicate the rank of the access mechanism among other transmitted access mechanisms 208.

The search module 108 may transmit additional data to the user device 102 along with the access mechanisms 208 and the result scores 226. For example, the search module 108 may transmit data (e.g., text and/or images) to be included in the user selectable links. Data for the user selectable links (e.g., text and/or images) may be referred to herein as “link data” (e.g., link data 230). The user device 102 displays the user selectable links to the user based on received link data 230. Each user selectable link may be associated with an access mechanism included in the search results 206 such that when a user selects a link, the user device 102 launches the application referenced in the access mechanism and sets the application into the state specified by the access mechanism.

FIG. 2 shows an example list of user selectable links 210 that a user device 102 may display to a user. Each of the links 210 includes link data. For example, each of the links 210 includes text (e.g., an application or business name) that may describe an application and a state of an application. Each of the links 210 may include an access mechanism so that if a user selects one of links 210, the user device 102 launches the application and sets the application into a state that is specified by the access mechanism associated with the selected link.

User devices 102 can be any computing devices that are capable of providing search queries to the search system 100. User devices 102 include, but are not limited to, smart phones, tablet computers, laptop computers, and desktop computers. User devices 102 may also include other computing devices having other form factors, such as computing devices included in vehicles, gaming devices, televisions, or other appliances (e.g., networked home automation devices and home appliances).

The user devices 102 may use a variety of different operating systems. In an example where a user device 102 is a mobile device, the user device 102 may run an operating system including, but not limited to, ANDROID® developed by Google Inc. or IOS® developed by Apple Inc. Accordingly, the operating system 224 running on the user device 102 may include, but is not limited to, one of ANDROID® and IOS®. In an example where a user device is a laptop or desktop computing device, the user device may run an operating system including, but not limited to, MICROSOFT WINDOWS® by Microsoft Corporation, MAC OS® by Apple, Inc., or Linux. User devices 102 may also access the search system 100 while running operating systems other than those operating systems described above, whether presently available or developed in the future.

In general, a user device 102 may communicate with the search system 100 using any application that can transmit search queries to the search system 100. In some examples, a user device 102 may run a native application that is dedicated to interfacing with the search system 100, such as a native application dedicated to searches (e.g., search application 216). In some examples, a user device 102 may communicate with the search system 100 using a more general application, such as a web-based application accessed using the web browser application 212. Although the user device 102 may communicate with the search system 100 using a web based application and/or a native search application, the user device 102 may be described hereinafter as using the native search application 216 to communicate with the search system 100.

The search application 216 may display a search field 214 on a graphical user interface (GUI) in which the user can enter search queries. The user may enter a search query using a touchscreen or physical keyboard, a speech-to-text program, or other form of user input. In general, a search query may be a request for information retrieval (e.g., search results) from the search system 100. For example, a search query may be directed to retrieving a list of links to application functionality or application states in examples where the search system 100 is configured to generate a list of access mechanisms as search results. A search query directed to retrieving a list of links to application functionality may indicate a user's desire to access functionality of one or more applications described by the search query.

A user device 102 may receive a set of search results 206 from the search module 108 that are responsive to the query wrapper 200 transmitted to the search system 100. The GUI of the search application 216 displays (e.g., renders) the search results 206 received from the search module 108. The search application 216 may display the search results 206 to the user in a variety of different ways, depending on what information is transmitted to the user device 102. In examples where the search results 206 include a list of access mechanisms and link data, the search application 216 may display the search results to the user as a list of user selectable links including text and/or images.

The text and images in the links may include application names associated with the access mechanisms, text describing the access mechanisms, images associated with the application referenced by the access mechanisms (e.g., application icons), and images associated with the application state (e.g., application screen images) defined by the access mechanisms. In FIG. 2, the search results for the search query “subway” are rendered as a list of links 210 including text describing application/web states that may be launched in response to user selection of the links 210.

In some examples, user devices 102 may communicate with the search system 100 via a partner computing system (not illustrated). The partner computing system may be a computing system of a third party that may leverage the search functionality of the search system 100. The partner computing system may belong to a company or organization other than that which operates the search system 100. Example third parties that may leverage the functionality of the search system 100 may include, but are not limited to, internet search providers and wireless communications service providers. The user devices 102 may send search queries to the search system 100 and receive search results via the partner computing system. The partner computing system may provide a user interface to the user devices 102 in some examples and/or modify the search experience provided on the user devices 102.

The search data store 112 includes a plurality of different search records. Each search record may include data related to a state of an application, or data related to any other relevant search result that may be delivered by the search system. A search record may include a search record identifier (ID), search record information, link data, and one or more access mechanisms used to access functionality provided by an application. The data store 112 may include one or more databases, indices (e.g., inverted indices), tables, files, or other data structures which may be used to implement the techniques of the present disclosure. The search module 108 receives a query wrapper 200 and generates search results based on the data included in the data store 112.

FIG. 1 shows a plurality of data sources 104. The data sources 104 may be sources of data which the search system 100 (e.g., the record generation module 110) may use to generate and update the data store 112. The record generation module 110 retrieves data from one or more of the data sources 104. The data retrieved from the data sources 104 can include any type of data related to application states. The record generation module 110 may use the data retrieved from the data sources 104 to create and/or update one or more databases, indices, tables (e.g., an access table), files, or other data structures included in the data store 112.

For example, the record generation module 110 may create new search records and update existing search records based on data retrieved from the data sources 104. In some examples, some data included in the data sources 104 may be manually generated by a human operator. For example, some data included in the search records (e.g., record information) may be manually generated by a human operator. The record generation module 110 (or a human operator) may update the data included in the search records over time so that the search system 100 provides up-to-date results.

The data sources 104 may include a variety of different data providers. The data sources 104 may include data from application developers, such as application developers' websites and data feeds provided by developers. The data sources 104 may include operators of digital distribution platforms configured to distribute native applications to user devices 102. Example digital distribution platforms include, but are not limited to, the GOOGLE PLAY® digital distribution platform by Google, Inc. and the APP STORE® digital distribution platform by Apple, Inc.

The data sources 104 may also include other websites, such as websites that include web logs (i.e., blogs), application review websites, or other websites including data related to applications. Additionally, the data sources 104 may include social networking sites, such as “FACEBOOK@” by Facebook, Inc. (e.g., Facebook posts) and “TWITTER®” by Twitter Inc. (e.g., text from tweets). Data sources 104 may also include online databases that include, but are not limited to, data related to movies, television programs, music, and restaurants. Data sources 104 may also include additional types of data sources in addition to the data sources described above. Different data sources may have their own content and update rate.

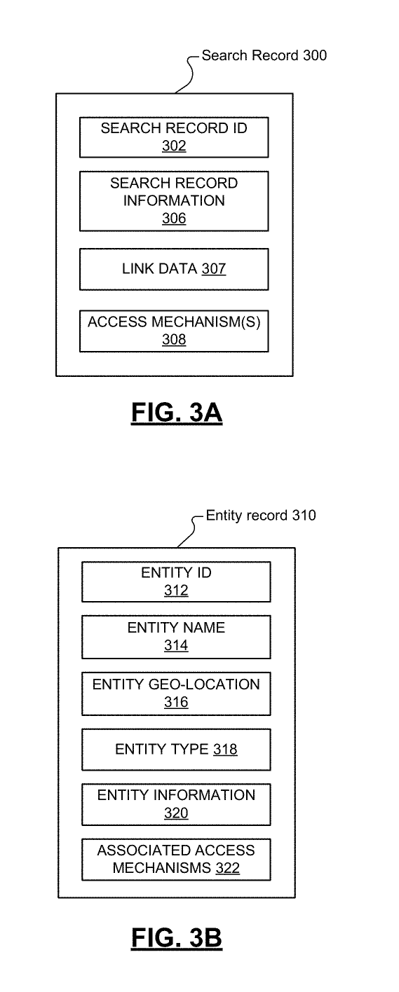

Referring now to FIG. 3A, an example search record 300 includes a search record identifier 302 (hereinafter “record ID 302”), search record information 306, link data 307, and one or more access mechanisms 308. The search record 300 may include data related to a state of a native application and/or website. The data store 112 may include a plurality of search records having a similar structure as the search record 300.

The record ID 302 may be used to identify the search record 300 among the other search records included in the data store 112. The record ID 302 may be a string of alphabetic, numeric, and/or symbolic characters (e.g., punctuation marks) that uniquely identify the search record 300 in which the record ID 302 is included.

In some examples, the record ID 302 may describe a function and/or an application state in human readable form. For example, the record ID 302 may include the name of the application referenced in the access mechanism(s) 308. In some examples, the record ID 302 may include a string in the format of a uniform resource locator (URL) of a web access mechanism for the search record 300, which may uniquely identify the search record.

The search record 300 includes one or more access mechanisms 308. The access mechanism(s) 308 may include one or more application access mechanisms, one or more web access mechanisms, and one or more application download mechanisms. The user device 102 may use the one or more application access mechanisms and the one or more web access mechanisms to access the same, or similar, functionality of the native/web application referenced in the record information 306. For example, the user device 102 may use the different access mechanism(s) 308 to retrieve similar information, play the same song, or play the same movie. The application download mechanisms may indicate sites (e.g., web/native, such as the GOOGLE PLAY® digital distribution platform) where the native applications referenced in the application access mechanisms can be downloaded.

The record information 306 may include data that describes an application state into which an application is set according to the access mechanism(s) 308 in the search record 300. Additionally, or alternatively, the record information 306 may include data that describes the function performed according to the access mechanism(s) 308 included in the search record 300.

The record information 306 may include a variety of different types of data. For example, the record information 306 may include structured, semi-structured, and/or unstructured data. In some implementations, the record generation module 110 may extract and/or infer the record information 306 from documents retrieved from the data sources 104. Additionally, or alternatively, the record information 306 may be manually generated data. The record generation module 110 may update the record information 306 so that up-to-date search results can be provided in response to a query wrapper.

In some examples, the record information 306 may include data that may be presented to the user by an application when the application is set in the application state specified by the access mechanism(s) 308. For example, if one of the access mechanism(s) 308 is an application access mechanism, the record information 306 may include data that describes a state of the native application after the user device 102 has performed the one or more operations indicated in the application access mechanism.

In one example, if the search record 300 is associated with a shopping application, the record information 306 may include data that describes products (e.g., names and prices) that are shown when the shopping application is set to the application state defined by the access mechanism(s) 308. As another example, if the search record 300 is associated with a music player application, the record information 306 may include data that describes a song (e.g., name and artist) that is played when the music player application is set to the application state defined by the access mechanism(s) 308.

The types of data included in the record information 306 may depend on the type of information associated with the application state and the functionality defined by the access mechanism(s) 308. In one example, if the search record 300 is for an application that provides reviews of restaurants, the record information 306 may include information (e.g., text and numbers) related to a restaurant, such as a category of the restaurant, reviews of the restaurant, and a menu for the restaurant. In this example, the access mechanism(s) 308 may cause the application (e.g., a web or native application) to launch and retrieve information for the restaurant (e.g., using the web browser application 212 or one of native applications 204). As another example, if the search record 300 is for an application that plays music, the record information 306 may include information related to a song, such as the name of the song, the artist, lyrics, and listener reviews. In this example, the access mechanism(s) 308 may cause the application to launch and play the song described in the record information 306.

Referring now to FIG. 3B, an example entity record 310 includes an entity ID 312 and/or an entity name 314 (e.g., a business ID, name, etc.), an entity geo-location 316, an entity type 318 that indicates the category of the entity (e.g., a restaurant business), entity information 320 describing the entity (e.g., a restaurant address, phone number, and open hours), and associated access mechanism(s) 322. An entity may refer to a person, place, or thing. For example, an entity may refer to a business, a product, a service, a piece of media content, a political organization/figure, a public figure, or a destination. In some examples, an entity may refer to a place having a defined latitude/longitude geo-location.

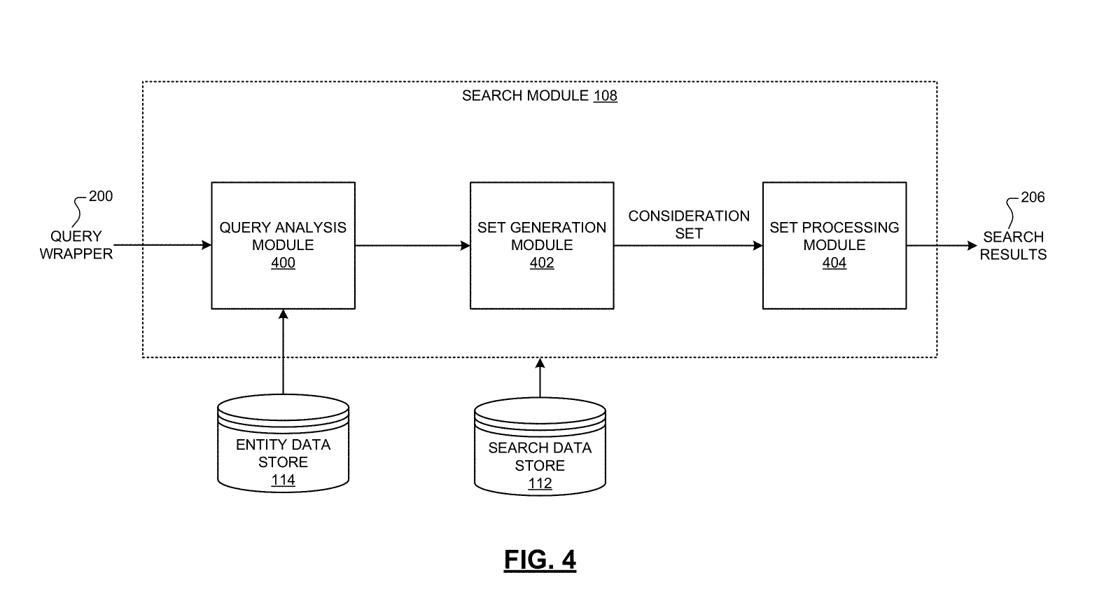

FIG. 4 illustrates an example search module 108 that includes a query analysis module 400, a consideration set generation module 402 (hereinafter “set generation module 402”), and a consideration set processing module 404 (hereinafter “set processing module 404”).

The query analysis module 400 receives the query wrapper 200. The query analysis module 400 analyzes the received search query 202. For example, the query analysis module 400 may perform various analysis operations on the received search query 202. Example analysis operations may include, but are not limited to, tokenization of the search query 202, filtering of the search query 202, stemming, synonymization, and stop word removal. The query analysis module 400 may identify the entities (e.g., entity name/ID) included in the search query based on matches between terms in the search query and terms in the entity records (e.g., the entity ID, entity type, and entity information).

The set generation module 402 identifies a plurality of search records based on the processed search query. For example, the set generation module 402 may identify a plurality of search records based on tags (e.g., entity records, IDs, etc.) assigned to the terms in the search query. In some examples, the set generation module 402 may identify the search records based on matches between terms of the search query 202 and terms in the search records. For example, the set generation module 402 may identify the search records based on matches between tokens generated by the query analysis module 400 and words included in the search records, such as words included in the record information 306.

The set generation module may identify search records based on the identified entities. For example, the set generation module may match entities in the search queries to entities included in the record information (e.g., entities associated with the state of the search record). The set generation module may select search records having matching entities for the consideration set. The set processing module may then score the search records based on matches between entities in the search query and the search records, along with other scoring features.

The set processing module 404 may score the search records in the consideration set in order to generate a set of search results 206. The scores associated with the search records may be referred to as “result scores.” The set processing module 404 may determine a result score for each of the search records in the consideration set. The result scores associated with a search record may indicate the relative rank of the search record (e.g., the access mechanisms) among other search records. For example, a larger result score may indicate that a search record is more relevant to the received search query 202.

The information conveyed by the search results 206 may depend on how the result scores 226 are calculated by the set processing module 404. For example, the result scores 226 may indicate the relevance of an application state to the search query 202, the popularity of an application state, or other properties of the application state, depending on what parameters the set processing module 404 uses to score the search records.

The set processing module 404 may generate result scores for search records in a variety of different ways. In some implementations, the set processing module 404 may generate result scores for search records based on tags (e.g., entity records) assigned to the terms in the search query.

In some implementations, the set processing module 404 generates a result score for a search record based on one or more scoring features. The scoring features may be associated with the search record, the search query 202, and/or data included in the processed search query. A search record scoring feature (hereinafter “record scoring feature”) may be based on any data associated with a search record. For example, record scoring features may be based on any data included in the record information of the search record. Example record scoring features may be based on metrics associated with a person, place, or thing described in the search record.

Example metrics may include the popularity of a place described in the search record and/or ratings (e.g., user ratings) of the place described in the search record. In one example, if the search record describes a song, a metric may be based on the popularity of the song described in the search record and/or ratings (e.g., user ratings) of the song described in the search record. The record scoring features may also be based on measurements associated with the search record, such as how often the search record is retrieved during a search and how often access mechanisms of the search record are selected by a user.

A query scoring feature may include any data associated with the search query 202 and/or the processed search query. For example, query scoring features may include, but are not limited to, a number of words in the search query 202, the popularity of the search query 202, and the expected frequency of the words in the search query 202.

A record-query scoring feature may include any data generated based on data associated with both the search record and at least one of the search query 202 and/or processed search query that resulted in identification of the search record by the set generation module 402. For example, record-query scoring features may include, but are not limited to, parameters that indicate how well the terms of the search query 202 match the terms of the record information of the identified search record. The set processing module 404 may generate a result score for a search record based on at least one of the record scoring features, the query scoring features, and the record-query scoring features.

The set processing module 404 may determine a result score based on one or more of the scoring features listed herein and/or additional scoring features not explicitly listed. In some examples, the set processing module 404 may include one or more machine learned models (e.g., a supervised learning model) configured to receive one or more scoring features. The one or more machine learned models may generate result scores based on at least one of the record scoring features, the query scoring features, and the record-query scoring features.

For example, the set processing module 404 may pair the search query 202 with each search record and calculate a vector of features for each (query, record) pair. The vector of features may include one or more record scoring features, one or more query scoring features, and one or more record-query scoring features. The set processing module 404 may then input the vector of features into a machine-learned regression model to calculate a result score for the search record. In some examples, the machine-learned regression model may include a set of decision trees (e.g., gradient boosted decision trees). In another example, the machine-learned regression model may include a logistic probability formula. In some examples, the machine learned task can be framed as a semi-supervised learning task, where a minority of the training data is labeled with human curated scores and the rest are used without human labels.

The result scores 226 associated with the search records (e.g., access mechanisms) may be used in a variety of different ways. The set processing module 404 and/or the user device 102 may rank the access mechanisms 208 based on the result scores 226 associated with the access mechanisms 208. In these examples, a larger result score may indicate that the access mechanism (e.g., the application state) is more relevant to a user than an access mechanism having a smaller result score. In examples where the user device 102 displays the search results 206 as a list, the user device 102 may display the links for access mechanisms having larger result scores nearer to the top of the results list (e.g., near to the top of the screen). In these examples, the user device 102 may display the links for access mechanisms having lower result scores farther down the list (e.g., off screen).

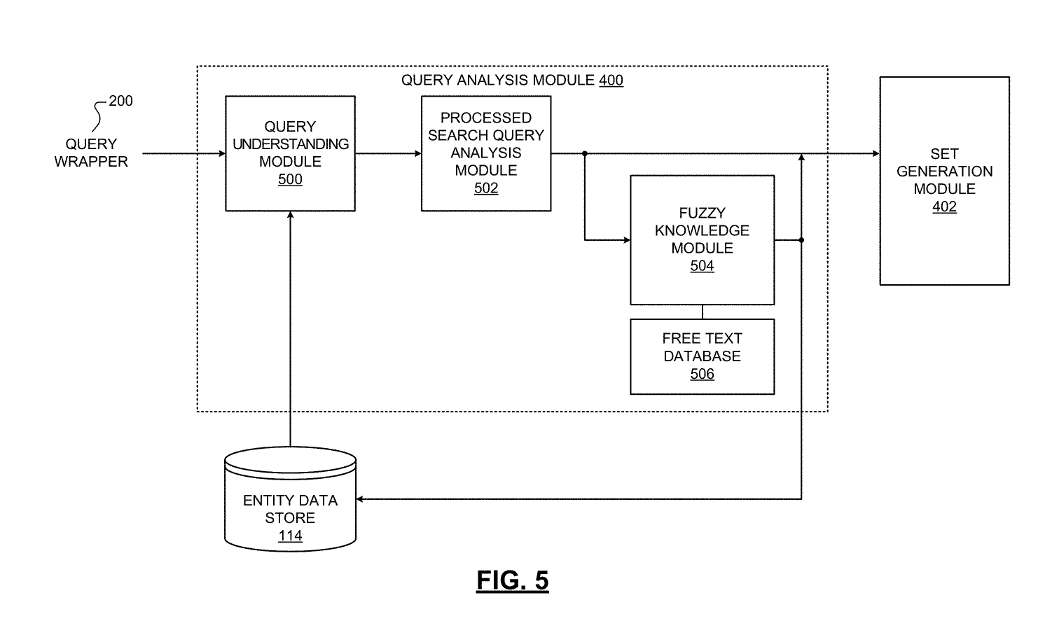

Referring now to FIG. 5, the query analysis module 400 according to the principles of the present disclosure is shown in more detail. The query analysis module 400 includes a query understanding module 500, a processed search query analysis module 502, and a fuzzy knowledge module 504. The query understanding module 500 receives the query wrapper 200 and generates a processed search query based on the data in the query wrapper 200 and the entity records (e.g., based on a search of the entity, or knowledge, data store 114). The processed search query analysis module 502 analyzes the processed search query to determine whether the processed search query is acceptable (i.e., whether an accuracy or confidence is above a threshold, whether the processed search query is complete, etc.) as described below in more detail.

If the processed search query is acceptable, the processed search query is provided to the set generation module 402. Conversely, if the processed search query is not acceptable, the processed search query is provided to the fuzzy knowledge module 504 (e.g., alternatively or in addition to providing the processed search query to the set generation module 402). The fuzzy knowledge module 504 further analyzes the processed search query and provides the processed search query with additional information according to the principles of the present disclosure. For example only, the additional information may include, but is not limited to, a list of candidate entity tags for each term in the search query that was not tagged (or was tagged with a low confidence, such as a confidence value less than a threshold) by the query understanding module 500.

For example, the query understanding module 500 may search the entity data store 114 to analyze the search query contained within the query wrapper 200 by determining meanings of each word in the search query. In some examples, the entity data store 114 includes a knowledge base (e.g., a comprehensive dictionary) associating each entity with a list of possible categorical meanings (e.g., a knowledge type). The query understanding module 500 attempts to match each word in the search query to a respective knowledge type (i.e., performs “knowledge tagging”) to generate the processed search query. For example, the processed search query may include respective tags (e.g., entity tags) for each term in the search query.

Accordingly, the accuracy of the processed search query is dependent upon the completeness and accuracy of the knowledge base, which must be frequently updated to reflect changes in language (e.g., new words, new meanings for existing words, new product names, new business names, development of casual and slang terms, synonyms, etc.). The fuzzy knowledge module 504 according to the principles of the present disclosure supplements the processed search query with additional information to compensate for inaccuracies as described below in more detail.

For illustration only, operation of the query understanding module 500 and the fuzzy knowledge module 504 will be described for an example search query “fly from SFO to X,” where X is an unknown term. For example, the query understanding module 500 may identify “fly” as a travel term and “SFO” as an airport. The query understanding module 500 may determine that “X” corresponds to an airport or city based on the pattern of the search query, a search of a free text database 506 (e.g., based on whether “X” appears within a predetermined proximity to “airport,” “shuttle,” other airport terminology, etc. in the free text database 506), and/or methods as described below.

The process search query analysis module 502 first determines whether the processed search query as generated by the query understanding module 500 is acceptable. If the process search query is acceptable, the process search query analysis module 502 provides the processed search query (e.g., unmodified) directly to the set generation module 402. Conversely, if the processed search query is not acceptable, the processed search query analysis module 502 instead (or, additionally) provides the processed search query to the fuzzy knowledge module 504 for additional processing.

For example, the processed search query analysis module 502 may determine whether the search query is acceptable based on whether each of the terms of the search query was tagged (i.e., identified with a respective entity, entity record, knowledge type, etc.), and/or whether the tagged terms match a set of grammar rules in an associated action group For example only, “fly” may be tagged as a flight term (e.g., a FlightTerm tag), “SFO” may be tagged as an airport, and “X” may not be tagged since it was not recognized by the query understanding module 500.

An action group may correspond to a group including a set of similar functions. For example, the search query of the present example may be assigned to a flight searching action group (e.g., a SearchFlight action group). In some examples, the processed search query analysis module 502 may assign an accuracy or confidence value to each tagged term and determine whether the processed search query is acceptable based on whether the assigned value is above a threshold. For example, the processed search query may be identified as unacceptable if any one of the values is less than the threshold, if more than one of the values is less than the threshold, if an average of the values is less than the threshold, etc.

Accordingly, the processed search query analysis module 502 may determine that the processed search query is not acceptable since one or more terms were not tagged (and, in some examples were critical to the search query), and then provide the processed search query to the fuzzy knowledge module 504.

The fuzzy knowledge module 504 performs one or more additional processing steps on the processed search query. For example, the steps may include, but are not limited to, performing an action group prediction on the processed search query, performing a partial grammar match on the processed search query based on a list of plausible action groups, performing query segmentation on the processed search query, performing candidate generation, performing candidate validation, and providing a validated processed search query. In some examples, the fuzzy knowledge module 504 may omit the steps related to performing an action group prediction and performing the partial grammar match.

For the action group prediction, the fuzzy knowledge module 504 generates a list of plausible action groups that could be associated with the search query. For example, the action groups may be determined based on tags assigned to the terms in the search query. As noted above, the search query “fly from SFO to X” may result in an action group prediction of “SearchFlight” because one or more of the terms are commonly associated with searches conducted to find flight information.

For example, for each search query and a respective action group, the fuzzy knowledge module 504 may generate a likelihood score (e.g., a percentage or probability) that the intent of the search query will be satisfied by search results from within that action group (e.g., by modeling each action group using Machine Learning techniques, analysis using grammar rules, etc.).

In an example where a sports team is included in the search (e.g., Golden State Warriors), predicted action groups may include a “sports” action group, a “ticketing” action group (e.g., EventTicket), and/or a “weather” action group. The sports action group may be assigned a relatively high likelihood score, while the EventTicket action group is assigned a mid-range score and the weather action group is assigned a relatively low score. The scores may be generated based on models implementing an intent confidence map incorporating scores from other action groups, entity tags assigned to the terms in the search query, etc. The list of plausible action groups may be generated based on an adjustable plausibility threshold. For example, action groups having a likelihood score less than the threshold may be removed from the list.

For partial grammar matching, the fuzzy knowledge module 504 analyzes a respective list of grammar rules associated with each of the predicted action groups to determine whether the tags assigned to the search query match the list of grammar rules for that action group. For example, grammar rules for the SearchFlight action group may include, but are not limited to, a sequence of tagged entities corresponding to one or more of “FlightTerm, Airport, Airport,” “FlightTerm, Airport, City,” “FlightTerm, City, City,” and/or “Airport, Airport.” Each grammar rule in the action group may be assigned a grammar match score for the search query. For example, “fly from SFO to X” may partially satisfy the “FlightTerm, Airport, Airport” rule and the “FlightTerm, Airport, City” rule, but does not satisfy the “FlightTerm, City, City” rule or the “Airport, Airport” rule. The grammar match score (e.g., a probability) corresponds to whether a respective rule is fully satisfied, partially satisfied, or not satisfied.

The list of plausible action groups may be further adjusted based on the grammar match scores for each action group. For example, if the likelihood score is high but the grammar match score is low for an action group, that action group may nonetheless be included in the list. Similarly, if the likelihood score is high and the grammar match score is high for an action group, that action group may nonetheless be included in the list. Conversely, an action group may be removed from the list if both the likelihood score and the grammar match score are low (e.g., as compared to respective thresholds).

For query segmentation, the fuzzy knowledge module 504 segments the search query according to respective action groups. For example, query segmentation may include removing stop words (i.e., words that are filtered out or removed) from the search query. For example only, the search query “fly from SFO to X” may be segmented into [fly, SFO, X].

In an example implementation, relevant free text that may be used to build a dictionary of phrases and counts is stored in the free text database 506. Free text includes, but is not limited to, text obtained (via crawling, scraping, etc.) from various sources, such as web pages, articles, online reviews, etc., that may include instances of one or more of the terms in the search query. For example, the free text database 506 may include common n-grams. The fuzzy knowledge module 504 may determine common n-grams that have a high probability of co-occurring with the terms in the search query. The fuzzy knowledge module 504 may determine which query segmentation calculated for the action group has a highest probability. The free text database 506 may be updated periodically to ensure that the most recent and relevant free text data is stored. For example only, the free text database 506 may be updated to incorporate a latest Wikipedia iteration, a most recent predetermined period (e.g., a forward moving time window) of text related to a social media platform (e.g., Twitter tweets), etc.

In other examples, the fuzzy knowledge module 504 may apply segmentation boundaries based on the part of speech of each of the terms in the search query. For example, the search query “¾ inch drill bit” may not have an exact match in the free text database 506. However, the free text database 506 may include text corresponding to similar products (e.g., a “½ inch drill bit”), allowing the fuzzy knowledge module 504 to produce a partial match. The fuzzy knowledge module 504 may also determine segmentation boundaries based on grammar and word order. For example, in the phrase “buy X Y cheap,” the fuzzy knowledge module 504 may group X and Y into the same segment based on the position of these words between “buy” and “cheap.”

For candidate generation, the fuzzy knowledge module 504 generates a list of candidates (e.g., entity tag candidates, or candidate tags) that may correspond to the missing tags (i.e., entity tags for the unknown terms in the search query, such as the “X” in “fly from SFO to X”) based on the predicted action groups, the partial grammar matching, the query segmentation, etc. Each candidate may include a word from the query, a knowledge type, and an action group. For example, for the query “fly from SFO to X,” the candidates may include, but are not limited to, “X, City, SearchFlight” and/or “X, Airport, SearchFlight.”

For candidate validation, the fuzzy knowledge module 504 selectively validates each candidate. For example, the fuzzy knowledge module 504 may assign a “True” or “False” value to each candidate based on the likelihood scores, the grammar match scores, the free text database 506, etc. For example only, the candidate “X, City, SearchFlight” may be assigned a “False” value (i.e., not valid) while the candidate “X, Airport, SearchFlight” is assigned a “True” value (i.e., valid).

In an example implementation, candidate validation may include both offline and online operations (i.e., stages). In the offline stage, relevant free text is collected and stored, which may also be used for query segmentation. In one example, the free text is collected via a specialized domain (e.g., a domain associated with a specific action group. For example, for a movie or film action group, the specialized domain may correspond to a website that compiles data about films.

Similarly, for a restaurant action group, the specialized domain may correspond to a website that compiles data (e.g., user reviews) about restaurants. In another example, the free text is collected via a general text source. For example, the general source may store a large variety of information and topics (e.g., Wikipedia, query logs, etc.).

Data corresponding to the collected free text may be indexed in a search engine (e.g., Elastic Search). For each knowledge type, a set of relevant words that frequently co-occur (i.e., “co-occurring words”) alongside the words of that knowledge type may be pre-calculated and stored. For example, for a movie title, the co-occurring words may include, but are not limited to, “movie,” “watch,” “imdb,” “review,” etc. To determine the co-occurring words, a subset of knowledge entities (i.e., “seeds”) that have both popular (e.g., well-known) and unique meanings is sampled. For example, the entity “Flight” may correspond to a movie (and therefore, may be popular), but may not be suitable as a seed since the word “flight” does not have a unique meaning.

The data can be queried using the seeds to collect documents that include seed/entity keywords and consider words that are within a certain window size of the keywords. If the document is semi-structured, different fields may be considered separately. If the data is collected from a specialized domain, an additional action group filter can be added to the query. In some implementations, an upper limit count may be implemented for each seed. For each near word (i.e., words within the window size of the seed/entity keyword that are candidates to be designated as co-occurring words), a relevance score may be calculated according to relevance score=P(word|knowledge seed)/P(word).

Words may be filtered according to a relevance score threshold, (e.g., to exclude neutral words), and a minimum occurrence count for the co-occurring words may be required. Accordingly, the set of co-occurring words may correspond to words having a relevance score above a threshold and an occurrence count above a threshold. Remaining near words (i.e., words that are within the window size but do not qualify as co-occurring words) may be included in a binary classification model that predicts whether a candidate word corresponds to a particular knowledge type.

In the online stage of candidate validation, the fuzzy knowledge module 504 identifies documents that contain each candidate and uses the identified documents to construct a feature set to fit into the binary classification model.

Accordingly, the output of the fuzzy knowledge module 504 may correspond to a processed search query including terms tagged by the query understanding module 500 as well as terms assigned one or more validated candidate tags by the fuzzy knowledge module 504. In another example, the fuzzy knowledge module 504 may only output the validated candidates for the terms of the search query that were not tagged by the query understanding module 500. Accordingly, the output of the fuzzy knowledge module 504 (validated candidates) may be combined with the output of the query understanding module 500 (the original processed search query) to be provided to the set generation module 402. The output of the fuzzy knowledge module 504 (i.e., the validated candidates) may also be provided to the entity data store 114. In this manner, the entity data store 114 can be updated to incorporate additional knowledge (e.g., additional candidate tags to be assigned to respective search terms) generated by the fuzzy knowledge module 504.

In various examples, any of the operations of the fuzzy knowledge module 504 may be performed online (i.e., by accessing one or more dynamic online resources to perform the partial grammar matching, candidate generation, etc.), offline (i.e., by accessing offline, static or pre-generated data, such as an offline free text database 506), and/or with some combination of online and offline components. The fuzzy knowledge module 504 may select between performing certain functions online or offline based on various factors including, but not limited to, time of day, whether the user device is wired or wireless, web traffic, processing time, network load, etc.

In some examples, the fuzzy knowledge module 504 may process, while offline, a batch of search queries found to be not acceptable by the analysis module 502. For example, the fuzzy knowledge module 504 may store one or more processed search queries identified in a predetermined period (e.g., one 24-hour period) that (i) were found to be not acceptable and/or (ii) were not successfully processed by the fuzzy knowledge module 504 (e.g., due to long processing times, unacceptable results, etc.). The fuzzy knowledge module 504 could then attempt to generate (e.g., once per day) validated candidate tags for these search queries and update the entity data store 114 accordingly.

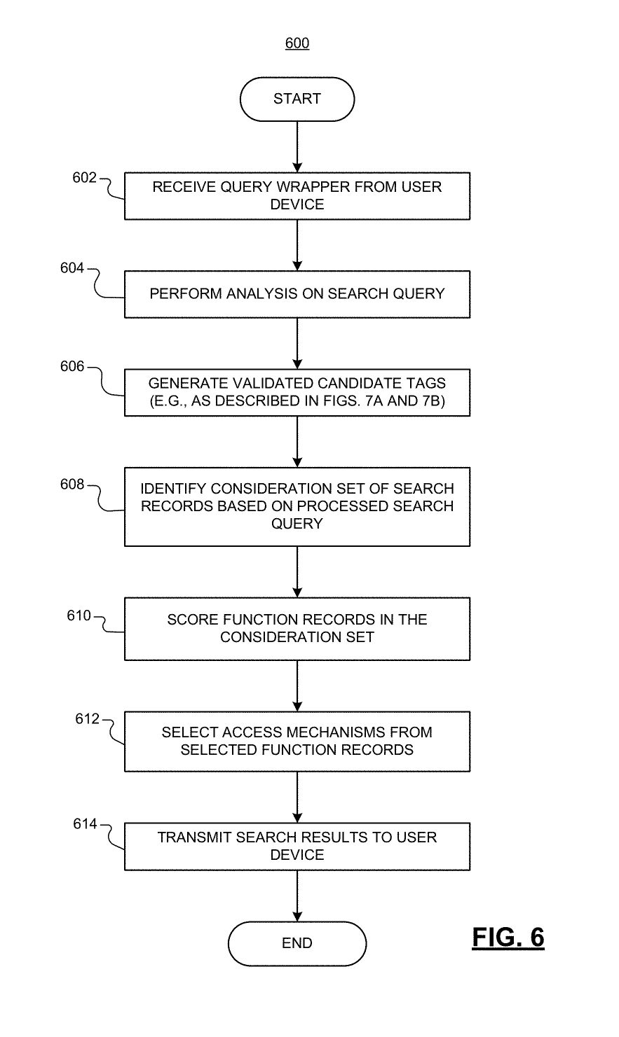

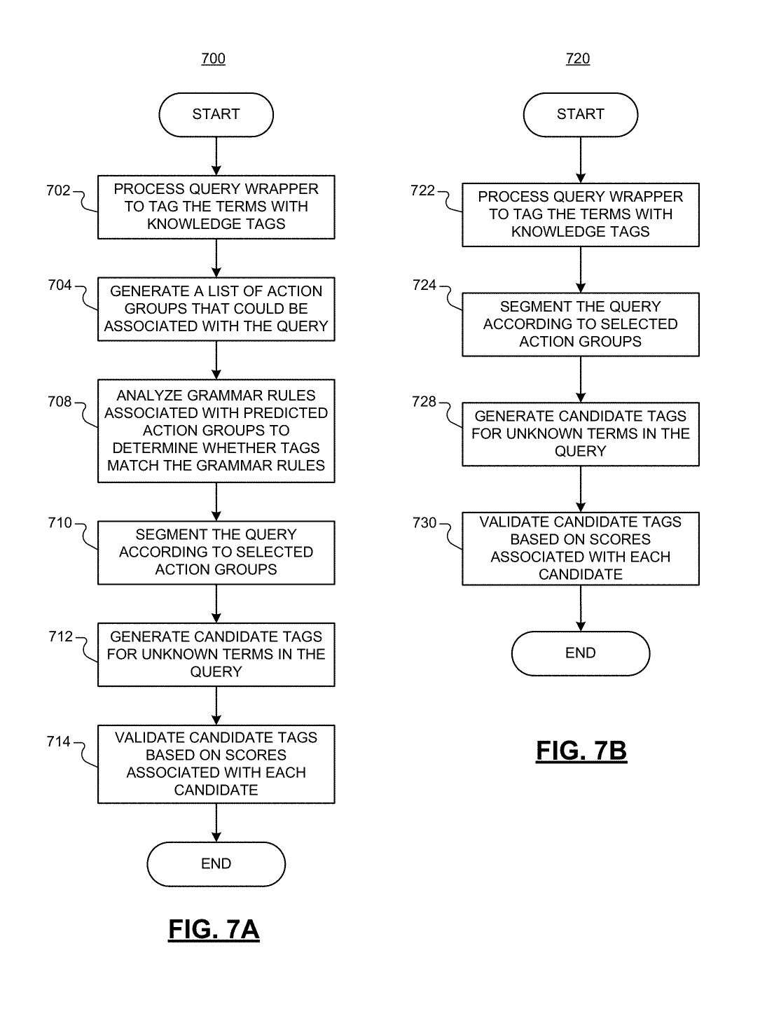

FIG. 6 illustrates an example method 600 for performing a search according to the present disclosure. The method 600 is described with reference to the search module 108 of FIG. 4. In block 602, the query analysis module 400 receives a query wrapper 200 from a user device. In block 604, the query analysis module 400 analyzes the search query 202 to assign tags to word in the search query, generate a processed search query including the tags, determine whether the processed search query is acceptable, etc. In block 606, the query analysis module 400 selectively generates validated candidate tags corresponding to the search query as described in more detail below in FIGS. 7A and 7B.

In block 608, the set generation module 402 identifies a consideration set of search records based on the search query 202 and/or the processed search query, as described above. In block 610, the set processing module 404 scores the function records of the consideration set (e.g., based on the processed search query). In block 612, the set processing module 404 selects access mechanisms from the scored search records. For example, the set processing module 404 may select access mechanisms from the search records associated with the largest result scores. In block 614, the set processing module 404 transmits search results 206 to the user device 102.

FIG. 7A illustrates an example method 700 for providing validated candidate tags according to the present disclosure. The method 700 is described with reference to the query analysis module 502 of FIG. 5. In block 702, the query understanding module 500 processes the query wrapper to tag each of the terms in the search query with entity, or knowledge, tags (i.e., performs knowledge tagging). In block 704, the fuzzy knowledge module 504 performs action group prediction. In block 708, the fuzzy knowledge module 504 performs a partial grammar match. In block 710, the fuzzy knowledge module 504 performs query segmentation. In block 712, the fuzzy knowledge module 504 performs candidate generation. In block 714, the fuzzy knowledge module 504 performs candidate validation and outputs one or more validated candidate tags, a processed search query including validated candidate tags, etc.

FIG. 7B illustrates another example method 720 for providing validated candidate tags according to the present disclosure. The method 700 is described with reference to the query analysis module 502 of FIG. 5. In this example, the query understanding module 500 did not tag any of the terms in the search query with an entity tag (e.g., the query understanding module 500 was not able to find a valid match for any of the search terms). In block 722, the query understanding module 500 processes the query wrapper but does not tag any of the terms in the search query with entity, or knowledge, tags (i.e., performs knowledge tagging). In block 724, the fuzzy knowledge module 504 performs query segmentation. In block 728, the fuzzy knowledge module 504 performs candidate generation. In block 730, the fuzzy knowledge module 504 performs candidate validation and outputs one or more validated candidate tags, a processed search query including validated candidate tags, etc.

Modules and data stores included in the systems represent features that may be included in the systems of the present disclosure. The modules and data stores described herein may be embodied by electronic hardware, software, firmware, or any combination thereof. Depiction of different features as separate modules and data stores does not necessarily imply whether the modules and data stores are embodied by common or separate electronic hardware or software components. In some implementations, the features associated with the one or more modules and data stores depicted herein may be realized by common electronic hardware and software components. In some implementations, the features associated with the one or more modules and data stores depicted herein may be realized by separate electronic hardware and software components.

The modules and data stores may be embodied by electronic hardware and software components including, but not limited to, one or more processing units, one or more memory components, one or more input/output (I/O) components, and interconnect components. Interconnect components may be configured to provide communication between the one or more processing units, the one or more memory components, and the one or more I/O components. For example, the interconnect components may include one or more buses that are configured to transfer data between electronic components. The interconnect components may also include control circuits (e.g., a memory controller and/or an I/O controller) that are configured to control communication between electronic components.

The one or more processing units may include one or more central processing units (CPUs), graphics processing units (GPUs), digital signal processing units (DSPs), or other processing units. The one or more processing units may be configured to communicate with memory components and I/O components. For example, the one or more processing units may be configured to communicate with memory components and I/O components via the interconnect components.

A memory component may include any volatile or non-volatile media. For example, memory may include, but is not limited to, electrical media, magnetic media, and/or optical media, such as a random access memory (RAM), read-only memory (ROM), non-volatile RAM (NVRAM), electrically-erasable programmable ROM (EEPROM), Flash memory, hard disk drives (HDD), magnetic tape drives, optical storage technology (e.g., compact disc, digital versatile disc, and/or Blu-ray Disc), or any other memory components.

Memory components may include (e.g., store) data described herein. For example, the memory components may include the data included in the search records of the data store. Memory components may also include instructions that may be executed by one or more processing units. For example, memory may include computer-readable instructions that, when executed by one or more processing units, cause the one or more processing units to perform the various functions attributed to the modules and data stores described herein.

The I/O components may refer to electronic hardware and software that provides communication with a variety of different devices. For example, the I/O components may provide communication between other devices and the one or more processing units and memory components. In some examples, the I/O components may be configured to communicate with a computer network. For example, the I/O components may be configured to exchange data over a computer network using a variety of different physical connections, wireless connections, and protocols.

The I/O components may include, but are not limited to, network interface components (e.g., a network interface controller), repeaters, network bridges, network switches, routers, and firewalls. In some examples, the I/O components may include hardware and software that is configured to communicate with various human interface devices, including, but not limited to, display screens, keyboards, pointer devices (e.g., a mouse), touchscreens, speakers, and microphones. In some examples, the I/O components may include hardware and software that is configured to communicate with additional devices, such as external memory (e.g., external HDDs).

In some implementations, the search system may be a system of one or more computing devices (e.g., a computer search system) that are configured to implement the techniques described herein. Put another way, the features attributed to the modules and data stores described herein may be implemented by one or more computing devices. Each of the one or more computing devices may include any combination of electronic hardware, software, and/or firmware described above. For example, each of the one or more computing devices may include any combination of processing units, memory components, I/O components, and interconnect components described above. The one or more computing devices of the search system may also include various human interface devices, including, but not limited to, display screens, keyboards, pointing devices (e.g., a mouse), touchscreens, speakers, and microphones. The computing devices may also be configured to communicate with additional devices, such as external memory (e.g., external HDDs).

The one or more computing devices of the search system may be configured to communicate with the network. The one or more computing devices of the search system may also be configured to communicate with one another. In some examples, the one or more computing devices of the search system may include one or more server computing devices configured to communicate with user devices (e.g., receive query wrappers and transmit search results), gather data from data sources, index data, store the data, and store other documents. The one or more computing devices may reside within a single machine at a single geographic location in some examples. In other examples, the one or more computing devices may reside within multiple machines at a single geographic location. In still other examples, the one or more computing devices of the search system may be distributed across a number of geographic locations.

The term memory is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

What is claimed is:

1. A system for providing search results in response to a search query, the system comprising:
a query understanding module configured to receive the search query and output a processed search query based on the search query, wherein the search query includes one or more words and the processed search query selectively includes tags assigned to the one or more words; and
a fuzzy knowledge module configured to receive the processed search query, generate a set of candidate tags for selected ones of the words in the search query, and selectively validate the candidate tags,
wherein the system is configured to provide the search results to a user device based in part on the candidate tags generated and validated by the fuzzy knowledge module.

2. The system of claim 1, wherein each of the tags identifies an entity associated with the respective word in the search query.

3. The system of claim 1, wherein the selected ones of the words in the search query correspond to at least one of (i) words in the search query that were not assigned a respective tag by the query understanding module and (ii) words in the search query that were assigned, by the query understanding module, a respective tag associated with a confidence value less than a threshold.

4. The system of claim 1, wherein the fuzzy knowledge module generates the set of candidate tags in response to a determination that none of the words in the search query were assigned tags by the query understanding module.

5. The system of claim 1, wherein the fuzzy knowledge module is further configured to predict a respective action group associated with each of the selected ones of the words in the search query, and wherein the respective action groups correspond to one or more functions related to the selected ones of the words in the search query.

6. The system of claim 5, wherein the fuzzy knowledge module is further configured to assign a likelihood score to each of the action groups, wherein the likelihood score indicates a probability that the search query will be satisfied by search results from within the respective action group.

7. The system of claim 5, wherein the fuzzy knowledge module is further configured to compare the words in the search query to sets of grammar rules associated with each of the respective action groups.

8. The system of claim 7, wherein the fuzzy knowledge module is further configured to assign a grammar match score to each of the sets of grammar rules based on the comparison.

9. The system of claim 7, wherein the fuzzy knowledge module is further configured to segment the search query based on the action groups and the sets of grammar rules.

10. The system of claim 9, wherein each of the candidate tags includes a word in the search query, a knowledge type identifier, and an action group identifier.

11. A method for providing search results in response to a search query, the method comprising:
receiving the search query;
outputting a processed search query based on the search query, wherein the search query includes one or more words and the processed search query selectively includes tags assigned to the one or more words;
generating a set of candidate tags for selected ones of the words in the search query;
selectively validating the candidate tags; and
providing the search results to a user device based in part on the validated candidate tags.

12. The method of claim 11, wherein each of the tags identifies an entity associated with the respective word in the search query.

13. The method of claim 11, wherein the selected ones of the words in the search query correspond to at least one of (i) words in the search query that were not assigned a respective tag and (ii) words in the search query that were assigned a respective tag associated with a confidence value less than a threshold.

14. The method of claim 11, further comprising generating the set of candidate tags in response to a determination that none of the words in the search query were assigned tags.

15. The method of claim 11, further comprising predicting a respective action group associated with each of the selected ones of the words in the search query, wherein the respective action groups correspond to one or more functions related to the selected ones of the words in the search query.

16. The method of claim 15, further comprising assigning a likelihood score to each of the action groups, wherein the likelihood score indicates a probability that the search query will be satisfied by search results from within the respective action group.

17. The method of claim 15, further comprising comparing the words in the search query to sets of grammar rules associated with each of the respective action groups.

18. The method of claim 17, further comprising assigning a grammar match score to each of the sets of grammar rules based on the comparison.

19. The method of claim 17, further comprising segmenting the search query based on the action groups and the sets of grammar rules.

20. The method of claim 19, wherein each of the candidate tags includes a word in the search query, a type identifier, and an action group identifier.
